(19) United States
(12) Patent Application Publication
(10) Pub. No.: US 2007/0225403 A1
(43) Pub. Date: Sep. 27, 2007

(54) Ink set, ink cartridge including the same, and inkjet recording apparatus employing the ink cartridge

(75) Inventor: Jong-in Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/591,509

(22) Filed: Nov. 2, 2006

(30) Foreign Application Priority Data
Mar. 25, 2006 (KR) 2006-27203

(51) Int. Cl. C09D 11/00

(52) U.S. Cl. 523/160; 523/161

(57) ABSTRACT

An ink set including an ink containing an alkali swellable latex and alkaline ink, an ink cartridge including the ink set, and an inkjet recording apparatus employing the ink cartridge.

### CROSS-REFERENCE TO RELATED APPLICATIONS

This application claims priority under 35 U.S.C. §119(a) from Korean Patent Application No. 10-2006-0027203, filed on Mar. 25, 2006, in the Korean Intellectual Property Office, the disclosure of which is incorporated herein in its entirety by reference.

### BACKGROUND OF THE INVENTION

1. Field of the Invention

The present general inventive concept relates to an ink set, an ink cartridge including the ink set, and an inkjet recording apparatus employing the ink cartridge, and more particularly, to an ink set that has a high anti-abrasion property, which is advantageous to print a full color image on a recording medium and to form a clear image without causing bleeding in a color interface area due to an ink containing an alkali swellable latex and an alkaline ink, an ink cartridge including the ink set, and an inkjet recording apparatus employing the ink cartridge.

2. Description of the Related Art

Printing methods are largely divided into non-impact printing and impact printing methods. Inkjet printing is one type of a non-impact printing method. In general, inkjet printing is less noisy than impact printing methods and a color image can be printed in a simpler way than by, for example, laser beam printing.

Inkjet printing is classified into continuous-stream printing and drop-on-demand (DOD) printing. In continuous-stream inkjet printing, ink is continuously ejected with pressure via orifices (nozzles). The ejected ink is separated into ink droplets at a specific distance from the orifices. Then, the ink droplets are charged according to a digital data signal, and orbits of the ink droplets are controlled while the ink droplets pass through an electromagnetic field. Thus, the ink droplets are recycled or directed to a gutter in a specific position on a recording medium. In drop-on demand printing, ink droplets are directly ejected from orifices to a position on a recording medium according to a digital data signal. Also, ink droplets which are not ejected onto the recording medium are not formed and discharged. Drop-on-demand printing is far simpler than continuous stream printing since it does not require ink recovery, charge, or deflection.

Drop-on-demand printing is divided into thermal inkjet (or bubble jet) printing and piezoelectric inkjet printing.

In thermal inkjet printing, ink is ejected by pressure generated by an expansion of bubbles formed by heating the ink. Thus, ink droplets can be ejected at a high speed. In addition, in a thermal inkjet printing apparatus, nozzles can be aligned at close intervals to each other. Drop-on-demand printing is simpler, faster, and more cost-effective than continuous stream printing.

Recently, there have been attempts to reduce a dot size of an inkjet printer, to increase an operating speed of the inkjet printer, and to print images having a high resolution. In order to obtain a smaller dot size, a head of an inkjet printer must have smaller nozzle openings. However, such smaller nozzle openings can be easily clogged, and also a size of inkjet droplets is affected by precipitates. In addition, a composition of ink affects nozzle clogging. Thus, a wetting agent is usually added to ink to solve this problem.

In general, ink for inkjet printing should not cause nozzle clogging, should maintain a stability of ink discharge, and should have a sufficiently high optical density. Also, when a color image is printed using black ink together with, for example, at least one color ink selected from among magenta ink, cyan ink, yellow ink, red ink, green ink, and blue ink, an image quality should not deteriorate due to bleeding at an interface between a black image part and a color image part on a recording medium where ink is non-homogeneously mixed.

In order to prevent or reduce bleeding, a method of increasing a permeability of ink into a recording medium by an addition of surfactants (Japanese Patent Application Laid-open No. 55-65269), and a method of shortening a drying time of ink by using a volatile solvent (Japanese Patent Application Laid-open No. 55-66976) have been suggested.

However, in the above conventional methods, there is a problem in that a stability of ink discharge decreases due to a use of a specific additive, and an optical density and a quality of images decrease due to an excessive penetration of ink into a recording medium.

### SUMMARY OF THE INVENTION

The present general inventive concept provides an ink set that has a high anti-abrasion property, which is advantageous to print a full color image on a recording medium and to form a clear image without causing bleeding at a color interface area, an ink cartridge including the ink set, and an inkjet recording apparatus employing the ink cartridge.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink set including a first ink comprising a first colorant, an alkali swellable latex, an organic solvent, and water, and a second ink comprising a second colorant, an organic solvent, and water, the second ink having a pH of at least 8.

The foregoing and/or other aspects and utilities of the present general inventive concept may also be achieved by providing an ink cartridge including the ink set.

The foregoing and/or other aspects and utilities of the present general inventive concept may also be achieved by providing an inkjet recording apparatus employing the ink cartridge including the ink set.

The foregoing and/or other aspects and utilities of the present general inventive concept may also be achieved by providing an ink set, including a first ink composition comprising a first colorant and an alkali swellable latex including at least one functional group, and a second ink composition comprising a second colorant different from the first colorant.

The at least one functional group may include a —COOH group or an —SO₃H group at a pH of less than 8. The at least one functional group may include an anionic group at a pH of 8 or more. The anionic group is a —COO⁻ group or an—SO₃⁻ group. The alkali swellable latex may have a pKₐ of less than 8. The second ink composition may have a pH of at least 8.

The first in composition may further include a first organic solvent, and the second ink composition may further include a second organic solvent. The first organic solvent may be the same as the second organic solvent. An amount of the first organic solvent may be about 0.5 to about 20 parts by weight based on 1 part by weight of the first colorant, and an amount of the second organic solvent may be about 0.5 to about 20 parts by weight based on 1 part by weight of the second colorant. The first organic solvent may include a mixture of a co-solvent and an amide compound, and an amount of the amide compound may be about 0.1 to about 50 parts by weight based on 1 part by weight of the first colorant. The second organic solvent may include a mixture of a co-solvent and an amide compound, and an amount of the amide compound may be about 0.1 to about 50 parts by weight based on 1 part by weight of the second colorant.

At least one of the first and second ink compositions may further include at least one additive selected from the group consisting of a wetting agent, a surfactant, a viscosity modifier, and a pH controller.

The foregoing and/or other aspects and utilities of the present general inventive concept may also be achieved by providing an ink set, including a first ink composition including an alkali swellable latex, and a second ink composition having a pH of at least 8. The first ink composition may include a first colorant, and the second ink composition may include a second colorant that is a different color than the first colorant.

The foregoing and/or other aspects and utilities of the present general inventive concept may also be achieved by providing an ink set, including an ink composition including a colorant and alkali swellable latex having at least one anionic functional group at a pH of 8 or more. The ink set may further include a second ink composition including a second colorant that is different from the first colorant, the second ink composition having a pH of at least 8.

The foregoing and/or other aspects and utilities of the present general inventive concept may also be achieved by providing a method of making an inkjet ink set, including mixing a first colorant, an alkali swellable latex, and an organic solvent in water to form a first mixture and filtering the first mixture, mixing a second colorant different from the first colorant and an organic solvent in water to form a second mixture and filtering the second mixture, and mixing the first and second filtered mixtures to form the in set.

The foregoing and/or other aspects and utilities of the present general inventive concept may also be achieved by providing an inkjet image forming method, including incorporating into an inkjet image forming apparatus an inkjet ink set including a first ink including a first colorant, an alkali swellable latex, and an organic solvent, and a second ink including a second colorant different from the first colorant and an organic solvent, and ejecting droplets of the inkjet ink set in an image-wise pattern onto a printing medium. The inkjet image forming apparatus may be at least one of thermal image forming apparatus, a piezoelectric forming apparatus, a shuttle-type image forming apparatus, and an array-type image forming apparatus.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic diagram illustrating a swelling of an alkali swellable latex in an ink set at a predetermined pH, according to an embodiment of the present general inventive concept.

FIG. 2 is a perspective view illustrating an inkjet recording apparatus, according to an embodiment of the present general inventive concept.

FIG. 3 is a sectional view illustrating an ink cartridge, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The present general inventive concept provides an ink set including at least two different color inks. According to an embodiment of the present general inventive concept, a first ink of the at least two different color inks may include a first colorant, an alkali swellable latex, an organic solvent, and water, and a second ink of the at least two different color inks may include a second colorant of a color different from the first colorant, an organic solvent, and water. A pH of the second ink may be at least 8. The alkali swellable latex according to the present embodiment may include a relatively closely distributed anion, such as a —CO₂ group⁻ or an —SO₃²⁻ group, on a surface thereof at a pH of 8 or more.

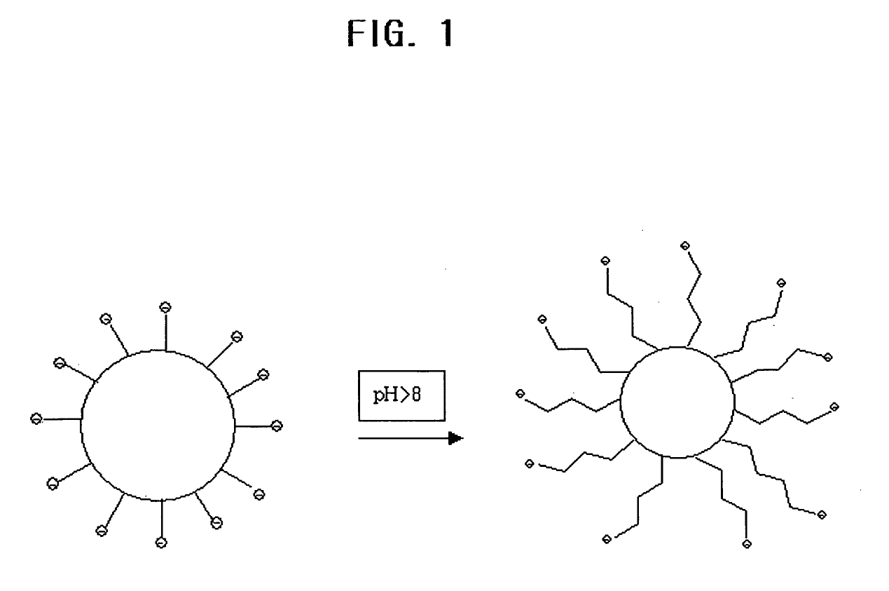

FIG. 1 is a schematic diagram illustrating a swelling of an alkali swellable latex in an ink set, according to the present general inventive concept, at a pH greater than 8. As illustrated in FIG. 1, when the pH is less than 8, the alkali swellable latex is stabilized in an aqueous solution maintaining a colloid state. However, when the pH is 8 or more, a functional group on the surface of the alkali swellable latex (e.g., a —COOH group or an —SO₃H group) loses a proton (i.e., an H⁺, or hydrogen cation) and turns into an anion (such as a —COO⁻ anion or an —SO₃⁻ anion. Thus, the alkali swellable latex may have a pKₐ of less than 8.

When the functional group in the alkali swellable latex turns into the anion as described above, a solubility of the alkali swellable latex in water increases. Thus, water as a solvent penetrates between high molecular branches in the alkali swellable latex, thereby expanding spaces between the high molecular branches. Hence, the alkali swellable latex particles swell. Also, an electrostatic repulsion between multiple anions on the surface of the alkali swellable latex accelerates the swelling of alkali swellable latex particles. As a result, a viscosity of ink containing the alkali swellable latex remarkably increases, and thus, movements of the ink on a paper rapidly slow down.

That is, by using the ink set including a combination of the first ink including the alkali swellable latex and the second ink having a pH of at least 8 in an inkjet image forming apparatus, when the first ink and second ink printed on a printing medium contact each other, movements of the inks slow down because a viscosity of the alkali swellable latex in the first ink rapidly increases. Thus, a blending of the first ink and the second ink is interrupted, and as a result, bleeding in a color interface area can be decreased.

The alkali swelling latex in the first ink can also function as a binder, and thus an anti-abrasion property of an image printed using the ink set including the first ink is high.

The alkali swellable latex is not limited to being a specific alkali swellable latex, but should include an anionic functional group. For example, the surface of the alkali swelling latex may include a —CO₂⁻ group or an —SO₃⁻ group. Examples of suitable alkali swellable latexes according to embodiments of the present general inventive concept include, but are not limited to, SN-634, SN-636, SN-920, SN-922, SN-924, SN-926, and the like, available from Sannopco.

A total amount of the alkali swellable latex of the first ink in the ink set according to the present embodiment may be in a range of about 0.01 to about 2 parts by weight based on 1 part by weight of the first colorant. When the amount of the alkali swellable latex is less than about 0.01 parts by weight, color bleeding cannot be prevented. When the amount of the alkali swellable latex is more than about 2 parts by weight, the viscosity of the first ink undesirably increases, thus decreasing a stability of the ink set including the first ink during long preservation time periods.

The first and second colorants may be self-dispersible dyes, self-dispersible pigments, or pigments or dyes used together with a dispersing agent.

In embodiments of the present general inventive concept, the first colorant of the first ink in the ink set may be one of a black, a magenta, a cyan, a red, a green, or a yellow colorant, and the second colorant of the second ink, which is different from the first colorant, may be a different one of a black, a magenta, a cyan, a red, a green, and a yellow colorant.

According to an embodiment of the present general inventive concept, the first colorant may be a black pigment and the second colorant may be at least one dye or pigment selected from the group consisting of magenta, cyan, yellow, red, green, and blue dyes or pigments.

The organic solvent used in the first and second inks of the ink set according to the present embodiment may be a co-solvent, an amide based compound, or mixtures thereof. A total amount of the organic solvent in the first ink and the second ink, respectively, may be in a range of about 0.5 to about 20 parts by weight based on 1 part by weight of the respective colorant. When the amount of the organic solvent is less than about 0.5 parts by weight, it is difficult to provide a desired wetting effect and a desired storage stability. When the amount of the organic solvent exceeds about 20 parts by weight, a viscosity of the corresponding ink increases and a particle size of the corresponding ink greatly increases.

Examples of the co-solvent include, but are not limited to, an alcohol compound (such as methyl alcohol, ethyl alcohol, n-propyl alcohol, isopropyl alcohol, n-butyl alcohol, sec-butyl alcohol, t-butyl alcohol, and isobutyl alcohol), a polyhydric alcohol compound (such as 1,6-hexanediol, 1,2-hexanediol, ethylene glycol, diethylene glycol, triethylene glycol, propylene glycol, butylene glycol, 1,4-butanediol, 1,2,4-butanetriol, 1,5-pentanediol, 1,2,6-hexanetriol, trimethanol propane, hexylene glycol, glycerol, and poly(ethylene glycol)), a ketone compound (such as acetone, methylethyl ketone and diacetone alcohol), an ester compound (such as ethyl acetate and ethyl lactate), a lower alkyl ether compound (such as ethylene glycol monomethyl ether, ethylene glycol monoethyl ether, diethylene glycol methyl ether, diethylene glycol ethyl ether, diethylene glycol monobutyl ether, diethylene glycol diethyl ether, triethylene glycol monomethyl ether, and triethylene glycol monoethyl ether), a sulfur-containing compound (such as dimethyl sulfoxide, tetramethylene sulfone, and thioglycol), and mixtures thereof.

The amide compound may be at least one compound selected from the group consisting of 2-pyrrolidone, 2-piperidone, N-methyl-pyrrolidone, caprolactam, tetrahydro-2-pyrimidone, 3-methyl-tetrahydro-2-pyrimidone, 2-imidazolidinone, dimethyl imidazolidinone, diethyl imidazolidinone, butyl urea, 1,3-dimethyl urea, ethyl urea, propyl urea, isopropyl urea, and 1,3-diethyl urea.

When a mixture of the co-solvent and the amide based compound is used as the organic solvent, a total amount of the amide compound may be in a range of about 0.1 to about 50 parts by weight based on 1 part by weight of the organic solvent.

The total amount of the water in first and second ink sets, respectively, of the ink set of the present embodiment may be in a range of about 1 to about 30 parts by weight based on 1 part by weight of the respective colorant. When the amount of the water is less than 1 part by weight, a viscosity of the corresponding ink increases due to high density of the colorant in an aqueous ink solution. When the amount of the water is greater than about 30 parts by weight, the amount of the colorant in the corresponding ink is too small to express colors.

The first and second inks according to the present embodiment may further include an additive, such as a wetting agent, a surfactant, a viscosity modifier, a pH controller, and the like.

The wetting agent is used to prevent clogging of the corresponding ink in a nozzle, and may be, for example, a polyhydric alcohol. Specific examples of the wetting agent include, but are not limited to, glycerin, ethylene glycol, diethylene glycol, triethylene glycol, propylene glycol, dipropylene glycol, hexylene glycol, 1,3-butanediol, 1,4-butanediol, 1,5-pentanediol, 2-butene-1,4-diol, 2-methyl-2-pentanediol, and mixtures thereof.

The surfactant controls a surface tension of the corresponding ink to stabilize a jetting performance of the corresponding ink in nozzles and to regulate a penetration of the corresponding ink into a recording medium. An anionic surfactant, a cationic surfactant, a non-ionic surfactant, or mixtures thereof may be used as the surfactant.

The viscosity modifier controls the viscosity of the first and second inks, respectively, to maintain smooth jetting from nozzles. The viscosity modifier may be, but is not limited to, casein, hydroxymethylcellulose, carboxymethylcellulose, and the like.

The pH controller may be an acid or a base to control the pH. In this case, the acid or the base increases a solubility of the wetting agent in the solvent and stabilizes the colorant (e.g., a pigment) of the corresponding ink.

A method of preparing the ink set, according to an embodiment of the present general inventive concept, will now be described.

First, a first colorant, an alkali swellable latex, and an organic solvent are added to water and mixed to form a first mixture. The first mixture is homogenized by thoroughly stirring the mixture using a mixer. Then, the homogenized mixture is filtered through a filter to obtain a first ink.

Separately, a second colorant different from the first colorant, an organic solvent, and water are mixed to form a second mixture, and the second mixture is filtered to obtain a second ink. The first ink and the second ink are then mixed together to obtain the ink set.

The ink set obtained using the above method has a surface tension of about 15 to about 70 dyne/cm and a viscosity of about 1 to about 20 cP at 20° C.

An ink set according to embodiments of the present general inventive concept can be used for a variety of purposes, such as in a toner, in paints, and in a coating composition. The ink set may be efficiently used in an inkjet image forming apparatus cartridge employing an array head. Unlike a shuttle-type inkjet image forming apparatus that prints while moving one chip, an inkjet image forming apparatus using an array head can perform high-speed printing using a plurality of chips and leads to a higher throughput. The array head may have, for example, at least 10,000 nozzles.

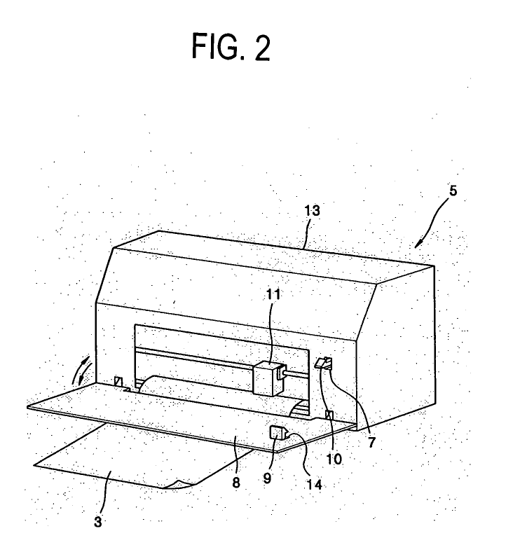

FIG. 2 is a perspective view illustrating an inkjet recording apparatus 5, according to an embodiment of the present general inventive concept. Referring to FIG. 1, an inkjet recording apparatus 5, according to an embodiment of the present general inventive concept, includes an ink cartridge 11 including an ink set, according to an embodiment of the present general inventive concept. The ink set may include at least two different color inks, a first ink of the at least two different color inks may include a first colorant, an alkali swellable latex, an organic solvent, and water, and a second ink of the at least two different color inks may include a second colorant of a color different from the first colorant, an organic solvent, and water, and a pH of the second ink may be at least 8. A printer cover 8 is connected through a hinge with a main body 13 of the inkjet recording apparatus 5. A region of a moving latch 10 protrudes through a hole 7. The moving latch 10 is engaged with a fixed latch 9, and the fixed latch 9 is connected to the inside of the printer cover 8 when the printer cover 8 is closed. The printer cover 8 has a recess 14 corresponding to the region of the moving latch 10 protruding through the hole 7. The ink cartridge 11 is mounted in the main body 13 and ink is ejected on a printing medium, such as a piece of paper 3, passing through the lower part of the ink cartridge 11.

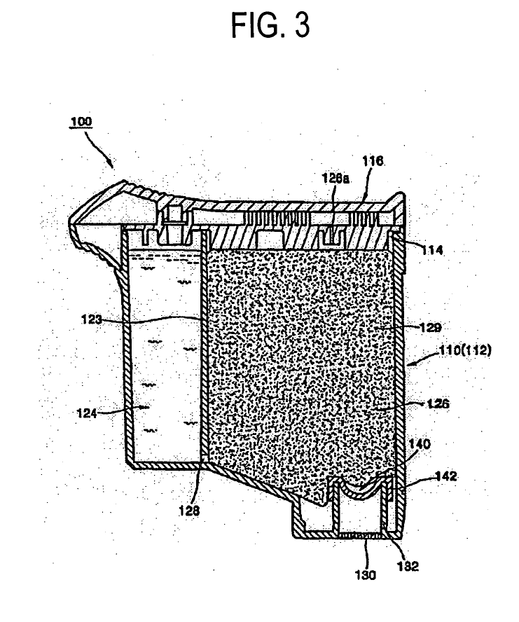

FIG. 3 is a sectional view illustrating an ink cartridge 100, according to an embodiment of the present general inventive concept. The ink cartridge 100 may include an ink set, according to an embodiment of the present general inventive concept. The ink set may include at least two different color inks, a first ink of the at least two different color inks may include a first colorant, an alkali swellable latex, an organic solvent, and water, and a second ink of the at least two different color inks may include a second colorant of a color different from the first colorant, an organic solvent, and water, and a pH of the second ink may be at least 8. The ink cartridge 100 includes a main body 110 forming an ink receiver 112, an inner cover 114 covering a top region of the ink receiver 112, and an outer cover 116 spaced apart from the inner cover 114 at a predetermined interval and sealing the ink receiver 112 and the inner cover 114.

The ink receiver 112 is divided into a first chamber 124 and a second chamber 126 by a vertical barrier wall 123. An ink passage 128 is formed in a lower part of the vertical barrier wall 123 between the first chamber 124 and the second chamber 126. Ink is filled into the first chamber 124 and a sponge 129, and then the second chamber 126. A vent hole 126a corresponding to the second chamber 126 is formed in the inner cover 114.

A filter 140 to prevent a nozzle 130 of a printer head from clogging is formed in a lower part of the second chamber 126 to filter impurities and minute bubbles from the ink. A hook 142 is formed in an edge region of the filter 140 and coupled to the top region of a standpipe 132. Ink in the ink receiver 120 passes through the nozzle 130 of the printer head and is ejected as small droplets on the printing medium.

The present general inventive concept will be described in greater detail with reference to the following examples. The following examples are for illustrative purposes only and are not intended to limit the scope of the general inventive concept.

### EXAMPLES

Materials listed below were used in the following examples.

The following colorants were used:

Black 1: Raven 5250, manufactured by Columbian Co.

Black 2: Regal 330, manufactured by Cabot Co.

Cyan 1: Direct Turquoise Blue, manufactured by Clariant.

Cyan 2: Direct Blue 199, manufactured by Hodogaya.

Magenta 1: Basacid Rot 495, manufactured by BASF.

Magenta 2: Acid Red 52, manufactured by Hodogaya.

Yellow 1: Yellow GGN, manufactured by Spectra.

Yellow 2: Basacid Yellow 099, manufactured by BASF.

The following organic solvents were used:

EG: Ethylene Glycol.

DEG: Diethylene Glycol.

Gly: Glycerine.

1,2,6-hex: 1,2,6-hexanetriol.

DEGMBE: Diethyleneglycol Monobutyl Ether.

The following amide compounds were used:

2-P: 2-pyrrolidone.

NMP: N-methyl-2-pyrrolidone.

Cyclo-P: Cyclohexyl pyrrolidone.

C-lactam: Caprolactam.

V-lactam: Valerolactam.

The following alkali swellable latexes were used:

ASL-1: SN-634 (available from Sannopco).

ASL-2: SN-636 (available from Sannopco).

ASL-3: SN-920 (available from Sannopco).

ASL-4: SN-922 (available from Sannopco).

ASL-5: SN-924 (available from Sannopco).

Ink samples were prepared using the above-listed colorants, organic solvents, and alkali swellable latexes according to the following method.

Each colorant, organic solvent, and alkali swellable latex was put into a 250-mL beaker according to the compositions of Table 1 based on predetermined ink properties, and then water was added to the beakers to bring a total weight in the beakers up to 100 g. Then, each of the mixtures in the beakers was mixed using a stirrer at 700 RPM for at least 30 minutes into a homogeneous state and then filtered through a 0.45 μm filter to obtain Inks 1-10 and Inks 1′-10′. In Table 1, the ink set of Example 1 includes Inks 1 and 2, the ink set of Example 2 includes Inks 3 and 4, etc.

TABLE 1

| | | Colorant | Organic solvent (parts by weight) + |
|---|---|---|---|
| | Sample | (parts by weight) | Alkali swellable latex (parts by weight) |
| Example 1 | Ink 1 | Black 1 (4) | EG (8), DEG (6), ASL-1 (0.3) |
| | Ink 2 | Cyan 1 (4) | Gly (10), DEGMBE (8), NMP (5) |
| Example 2 | Ink 3 | Black 1 (4) | EG (8), DEG (6), ASL-2 (8) |
| | Ink 4 | Magenta 1 (4) | 1,2,6-Hex (10), Cyclo-P (8) |
| Example 3 | Ink 5 | Black 1 (4) | EG (8), DEG (6), ASL-3 (4) |
| | Ink 6 | Yellow 1 (5) | Gly (10), DEG (6), V-lactam (4) |
| Example 4 | Ink 7 | Magenta 2 (4) | 1,2,6-Hex (10), DEG (6), |
| | | | Cyclo-P (6), ASL-4 (1.0) |
| | Ink 8 | Cyan 2 (4) | Gly (10), DEGMBE (2), NMP (7) |
| Example 5 | Ink 9 | Magenta 2 (4) | 1,2,6-Hex (10), DEG (6), Cyclo-P (6), ASL-5 |
| | | | (0.04) |
| | Ink 10 | Yellow 2 (5) | Gly (12), C-lactam (4) |
| Comparative | Ink 1′ | Black 1 (4) | EG (8), DEG (6) |
| Example 1 | Ink 2′ | Cyan 1 (4) | Gly (10), DEGMBE (8), NMP (5) |
| Comparative | Ink 3′ | Black 1 (4) | EG (8), DEG (6) |
| Example 2 | Ink 4′ | Magenta 1 (4) | 1,2,6-Hex (10), Cyclo-P (8) |
| Comparative | Ink 5′ | Black 1 (4) | EG (8), DEG (6) |
| Example 3 | Ink 6′ | Yellow 1 (5) | Gly (10), DEG (6), V-lactam (4) |
| Comparative | Ink 7′ | Magenta 2 (4) | 1,2,6-Hex (10), DEG (6), Cyclo-P (6) |
| Example 4 | Ink 8′ | Cyan 2 (4) | Gly (10), DEGMBE (2), NMP (7) |
| Comparative | Ink 9′ | Magenta 2 (4) | 1,2,6-Hex (10), DEG (6), Cyclo-P (6) |
| Example 5 | Ink 10′ | Yellow 2 (5) | Gly (12), C-lactam (4) |

### Experimental Example 1

### Storage Stability Test of Cartridge

The ink sets obtained from Examples 1-5 and Comparative Examples 1-5 were each put into a Samsung ink cartridge, left at ambient temperature (25° C.) and low temperature (−5° C.) for 2 weeks, and used to print. A degree of clogging of nozzles disabling ink ejection was evaluated. The results are described in Table 2 below, according to the following criteria:

□: 5% or less of the nozzles were clogged.

∘: 6-10% of the nozzles were clogged.

X: 11-20% of the nozzles were clogged.

XX: 21% or more of the nozzles were clogged.

### Experimental Example 2

### Anti-Abrasion Property Test

An ink cartridge M-50 (Samsung Electronics Co., Ltd.) was filled with each of the ink sets prepared according to Examples 1-5 and Comparative Examples 1-5 and used to print a bar of 2×10 cm on paper using a printer (MJC-2400C, Samsung Electronics Co., Ltd.). The printed paper was dried for 24 hours, and then rubbed 5 times using a tester. An OD (optical density) value of an image transferred to a blank sheet with respect to an OD value of the original bar image printed on the paper before being rubbed with the tester was calculated and expressed as a percentage. The results are described in Table 2, according to the following criteria, where A=(OD of the transferred image/OD of the original bar image)×100(%):

□: A □ 15.

∘: 15≦A<30.

X: 30≦A≦45.

XX: A □ 145.

### Experimental Example 3

### Bleeding Resistance Test

An ink cartridge M-50 (Samsung Electronics Co., Ltd.) and an ink cartridge C-60 (Samsung Electronics Co., Ltd.) were each filled with the black inks (Inks 1, 3, 5, 1′, 3′, and 5′) and color inks (Inks 2, 4, 6-10, 2′, 4′, and 6′-10′), respectively, to print test patterns using a printer (MJC-2400C, Samsung Electronics Co., Ltd.). After 30 minutes, a region of dot lines around a border line of adjacent different color images in which color mixing had occurred was observed using a microscope, and a degree of bleeding resistance was evaluated according to the following criteria (where a diameter of 1 dot at 600 dpi=100 μm) (refer to U.S. Pat. No. 5,854,307):

5: No color mixing occurred on the entire border line.

4: Color mixing occurred in a region having a width corresponding to a diameter of 1 dot.

3: Color mixing occurred in a region having a width corresponding to a diameter of 2 dots.

2: Color mixing occurred in a region having a width corresponding to a diameter of 3 dots.

1: Color mixing occurred in a region having a width corresponding to a diameter of 4 or more dots.

TABLE 2

| | Storage stability of | Anti-abrasion | |
|---|---|---|---|
| | cartridge | property | Bleeding resistance |
| Example 1 | □ | □ | 5 |
| Example 2 | □ | ◯ | 5 |
| Example 3 | ◯ | □ | 5 |
| Example 4 | □ | □ | 5 |
| Example 5 | □ | □ | 4 |
| Comparative | X | X | 2 |
| Example 1 | | | |
| Comparative | X | X | 2 |
| Example 2 | | | |
| Comparative | ◯ | XX | 3 |
| Example 3 | | | |
| Comparative | X | X | 2 |
| Example 4 | | | |
| Comparative | X | X | 2 |
| Example 5 | | | |

According to the results of Experimental Examples 1-3 described in Table 2, the ink sets of Examples 1-5 according to embodiments of the present general inventive concept have superior storage stability in a cartridge, superior anti-abrasion properties, and superior bleeding resistances as compared to the ink sets of Comparative Examples 1-5.

An ink set according to embodiments of the present general inventive concept include a combination of a first ink including an alkali swellable latex and a second ink having a pH of at least 8. An anti-abrasion property of the ink set is high when the ink set is used to print a full color image on a recording medium. Also, by using the ink set, a clear image can be formed without causing bleeding in a color interface area. The ink set can be used variously as, for example, an inkjet ink, a printing ink, paints, as well as for other purposes. Also, the ink set can be used to print on textile, paper, and other recording media. The ink set can also be used in the cosmetic industry, the ceramic industry, and other industries.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink set, comprising:
a first ink comprising a first colorant, an alkali swellable latex, an organic solvent, and water; and
a second ink comprising a second colorant having a different color than the first colorant, an organic solvent, and water, the second ink having a pH of at least 8.

2. The ink set of claim 1, wherein the alkali swellable latex comprises an anionic group.

3. The ink set of claim 2, wherein the anionic group comprises a group selected from the group consisting of a CO₂⁻ group and an SO₃⁻ group.

4. The ink set of claim 1, wherein a total amount of the alkali swellable latex in the first ink is in a range of about 0.01 to about 2 parts by weight based on 1 part by weight of the first colorant.

5. The ink set of claim 1, wherein the first colorant and the second colorant are selected from the group consisting of a self-dispersible dye, a self-dispersible pigment, and a pigment or a dye in combination with a dispersing agent.

6. The ink set of claim 1, wherein:
the first colorant is a black pigment; and
the second colorant is at least one of a color dye or pigment selected from the group consisting of magenta, cyan, yellow, red, green, and blue dyes or pigments.

7. The ink set of claim 1, wherein a total amount of the water in the first and second inks is in a range of about 1 to about 30 parts by weight based on 1 part by weight of the first and second colorants, respectively.

8. The ink set of claim 1, wherein a surface tension of the ink set is about 15 to about 70 dyne/cm, and a viscosity of the ink set is about 1 to about 20 Cp at 20° C.

9. An ink cartridge, comprising:
an ink set, comprising a first ink comprising a first colorant, an alkali swellable latex, an organic solvent, and water, and a second ink comprising a second colorant having a different color than the first colorant, an organic solvent, and water, the second ink having a pH of at least 8.

10. An inkjet recording apparatus, comprising:
an ink cartridge, containing an ink set comprising a first ink comprising a first colorant, an alkali swellable latex, an organic solvent, and water, and a second ink comprising a second colorant having a different color than the first colorant, an organic solvent, and water, the second ink having a pH of at least 8.

11. The inkjet recording apparatus of claim 10, comprising:
an array head having at least 10,000 nozzles.

12. An ink set, comprising:
a first ink composition including an alkali swellable latex; and
a second ink composition having a pH of at least 8.

13. The ink set of claim 12, wherein:
the first ink composition comprises a first colorant; and
the second ink composition comprises a second colorant that is a different color than the first colorant.

14. An ink set, comprising:
an ink composition including a colorant and alkali swellable latex having at least one anionic functional group at a pH of 8 or more.

15. The ink set of claim 14, further comprising:
a second ink composition including a second colorant that is different from the first colorant, the second ink composition having a pH of at least 8.

16. A method of making an inkjet ink set, comprising:
mixing a first colorant, an alkali swellable latex, and an organic solvent in water to form a first mixture and filtering the first mixture;
mixing a second colorant different from the first colorant and an organic solvent in water to form a second mixture and filtering the second mixture; and
mixing the first and second filtered mixtures to form the in set.

17. An inkjet image forming method, comprising:
incorporating into an inkjet image forming apparatus an inkjet ink set comprising a first ink including a first colorant, an alkali swellable latex, and an organic solvent, and a second ink including a second colorant different from the first colorant and an organic solvent; and
ejecting droplets of the inkjet ink set in an image-wise pattern onto a printing medium.

18. The method of claim 17, wherein the inkjet image forming apparatus is at least one of thermal image forming apparatus, a piezoelectric forming apparatus, a shuttle-type image forming apparatus, and an array-type image forming apparatus.
